(19) United States
(12) Patent Application Publication
(10) Pub. No.: US 2016/0241809 A1
(43) Pub. Date: Aug. 18, 2016

(54) CONTENT OUTPUT APPARATUS, CONTENT OUTPUT METHOD, AND RECORDING MEDIUM

(71) Applicant: CASIO COMPUTER CO., LTD., Tokyo (JP)

(72) Inventor: Yuuichi SAGOU, Tokyo (JP)

(73) Assignee: CASIO COMPUTER CO., LTD., Tokyo (JP)

(21) Appl. No.: 15/016,091

(22) Filed: Feb. 4, 2016

(30) Foreign Application Priority Data
Feb. 12, 2015 (JP) 2015-024879

(51) Int. Cl. H04N 7/025; H04W 4/00; H04W 8/00

(52) U.S. Cl. CPC H04N 7/025; H04W 8/005; H04W 4/008

(57) ABSTRACT

Provided is a content output apparatus including: an acquisition unit configured to acquire, from a communication partner terminal, language information used by the communication partner terminal; and an output unit configured to output a content on the basis of the language information.

### BACKGROUND OF THE INVENTION

1. Field of the Invention

The present invention relates to a content output apparatus, a content output method, and a recording medium.

2. Description of the Related Art

JP 2011-150221 A discloses a display device that performs various kinds of notice by projecting a human image onto a flat screen having a human shape in order to give impressive notice to viewers. Further, a technique for projecting a human image onto a three-dimensional screen has been studied to give more realistic impression to viewers.

However, in display devices known to the inventors, it is difficult to change contents depending on a language used by a viewer.

In view of this, an object of the present invention is to output a content in an appropriate language for a viewer.

### SUMMARY OF THE INVENTION

According to an embodiment of the present invention, there is provided a content output apparatus including: an acquisition unit configured to acquire, from a communication partner terminal, language information used by the communication partner terminal; and an output unit configured to output a content on the basis of the language information.

### BRIEF DESCRIPTION OF THE DRAWING

FIG. 1 shows a configuration of a content output system according to this embodiment;

FIG. 2 is a block diagram of a configuration of a digital signage device according to this embodiment;

FIG. 3 is a block diagram of a configuration of a terminal device according to this embodiment;

FIG. 4 shows a sequence of wireless communication according to this embodiment;

FIG. 5 is a flowchart of content output processing of the digital signage device according to this embodiment; and

FIG. 6 is a flowchart of content output processing of the terminal device according to this embodiment.

### DETAILED DESCRIPTION OF THE PREFERRED EMBODIMENT

Hereinafter, a wireless communication device according to an embodiment of the present invention will be described with reference to the drawings. Note that the same or corresponding parts are denoted by the same reference signs.

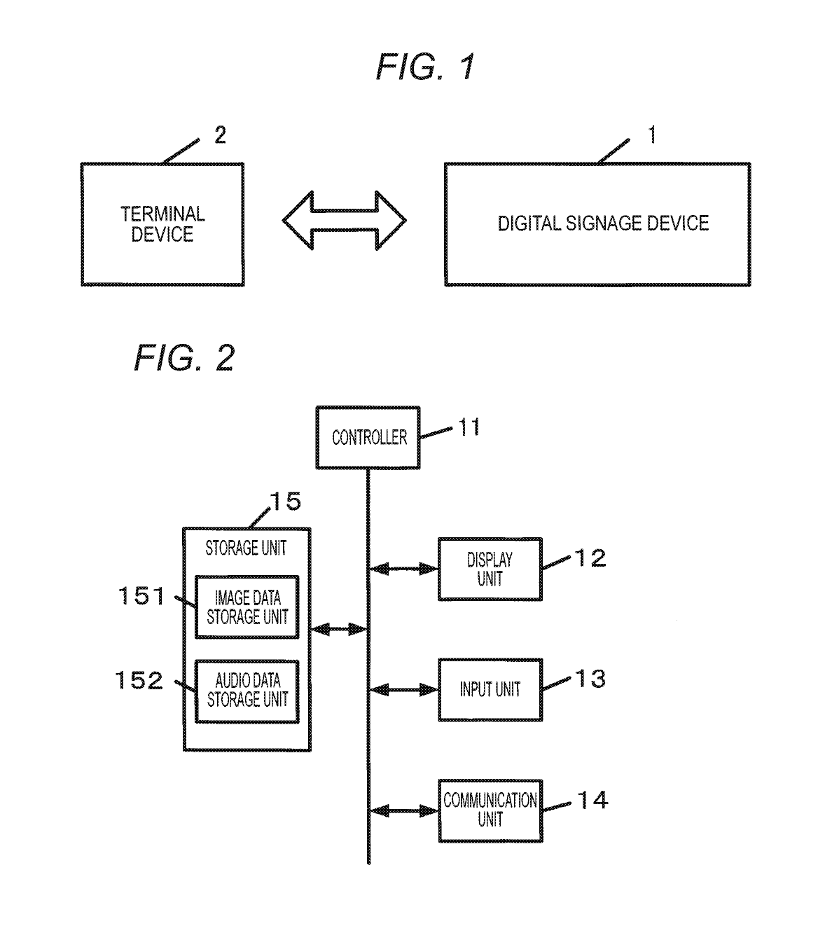

FIG. 1 shows a configuration of a content output system according to this embodiment. In a configuration example of FIG. 1, the content output system includes a digital signage device 1 and a terminal device 2 that performs wireless communication with the digital signage device 1. The digital signage device 1 and the terminal device 2 perform wireless communication with each other on the basis of, for example, Bluetooth (registered trademark) low energy (hereinafter, referred to as BLE.). The BLE is a standard (mode) developed for the purpose of low power consumption in a short-range wireless communication standard referred to as Bluetooth (registered trademark).

The digital signage device 1 is, for example, a projection device that irradiates a screen (not shown) with the use of a rear projection projector, is provided on a store, an exhibition hall, and the like, and reproduces contents such as explanation of products, guidance, and questionnaires. The terminal device 2 is, for example, a smartphone or a tablet personal computer.

As shown in FIG. 2, the digital signage device 1 includes a controller 11, a display unit 12, an input unit 13, a communication unit 14, and a storage unit 15, and the storage unit 15 includes an image data storage unit 151 and an audio data storage unit 152.

The controller 11 is constituted by a Central Processing Unit (CPU) and the like and includes the CPU that executes various programs stored in the storage unit 15 to perform predetermined calculation and control each unit and a memory serving as a working area when the programs are executed (both are not shown).

The display unit 12 is a projector that converts image data output from the controller 11 into projected light to irradiate a screen with the projected light.

For example, as a projector, it is possible to apply a Digital Light Processing (DLP) (registered trademark) projector including a digital micromirror device (DMD) which is a display element that performs display operation by turning on/off individual inclination angles of a plurality of (in the case of XGA, horizontal 1024 pixels×vertical 768 pixels) micromirrors arranged in an array at a high speed and forms an optical image with the use of reflected light thereof.

The input unit 13 accepts content change operation and the like from a user. The communication unit 14 transmits and receives a radio signal based on the BLE via an antenna (not shown). The communication unit 14 broadcasts a Beacon (advertise) based on the BLE, receives a connection request transmitted from the terminal device 2 in response to the Beacon, then establishes connection, and receives language information from the terminal device 2.

The storage unit 15 includes the image data storage unit 151 storing image data to be projected and the audio data storage unit 152 storing audio data to be output in accordance with the image data. The audio data storage unit 152 stores a plurality of pieces of audio data of languages in various countries, such as Japanese, English, and Chinese, corresponding to image data.

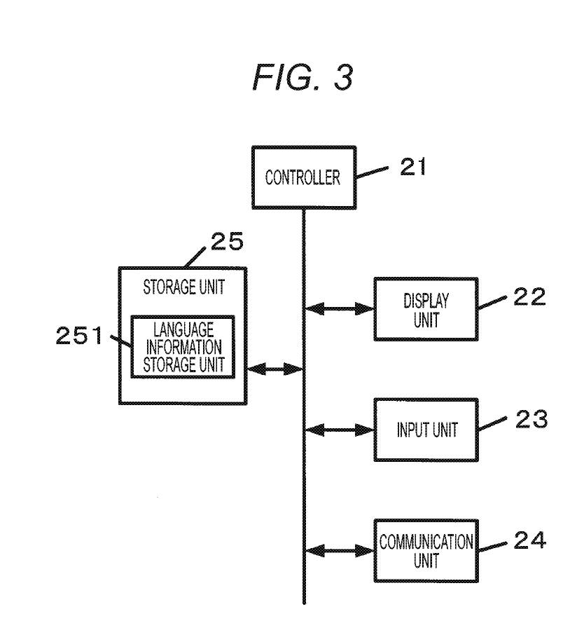

FIG. 3 is a block diagram of a configuration of the terminal device 2. The terminal device 2 includes a controller 21, a display unit 22, an input unit 23, a communication unit 24, and a storage unit 25, and the storage unit 25 includes a language information storage unit 251.

The controller 21 is constituted by a Central Processing Unit (CPU) and the like and includes the CPU that executes various programs stored in the storage unit 25 to perform predetermined calculation and control each unit and a memory serving as a working area when the programs are executed (both are not shown).

The display unit 22 includes, for example, a Liquid Crystal Display (LCD) or an Electroluminescence (EL) display.

The input unit 23 is, for example, a touchscreen, is provided on the display unit 22, and is an interface used for inputting content of operation performed by a user. The touchscreen includes, for example, a transparent electrode (not shown). In the case where a finger or the like of a user is touched, the touchscreen detects a position where a voltage is changed as a touch position and outputs information on the touch position to the controller 21 as an input instruction.

The storage unit 25 includes the language information storage unit 251 storing language information used by a user.

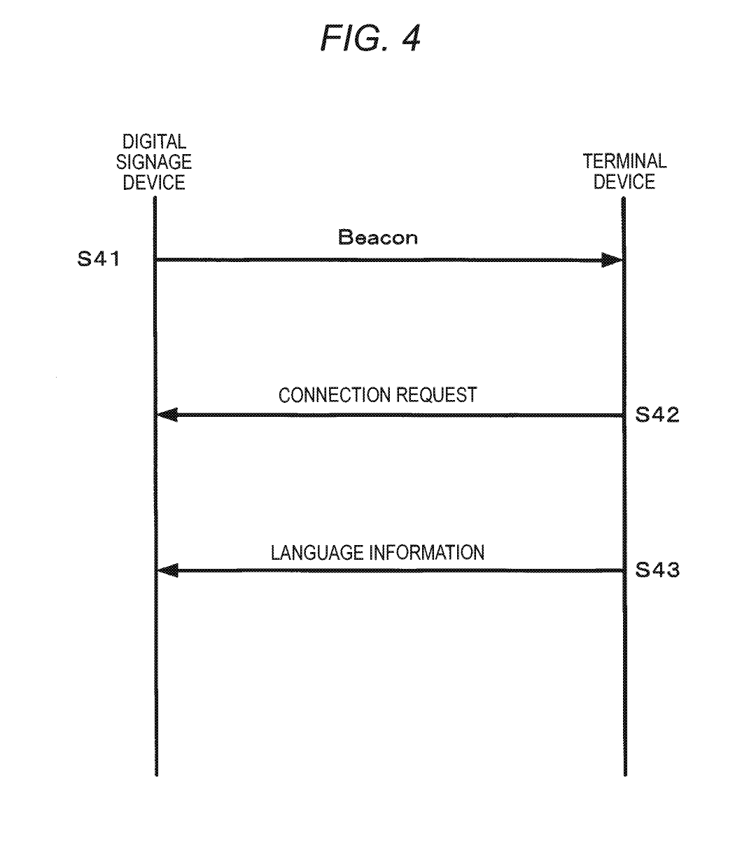

FIG. 4 shows a sequence of wireless communication for acquiring language information according to this embodiment.

First, the digital signage device 1 broadcasts a Beacon with the use of the communication unit 14 (Step S41). The Beacon contains identification information of the digital signage device 1.

Then, the terminal device 2 that has received the broadcasted Beacon specifies the digital signage device 1 on the basis of the identification information contained in the Beacon and transmits a connection request to the digital signage device 1 (Step S42).

The digital signage device 1 that has received the connection request establishes communication with the terminal device 2, and the terminal device 2 acquires used language information from the language information storage unit 251 and transmits the language information to the digital signage device 1 (Step S43).

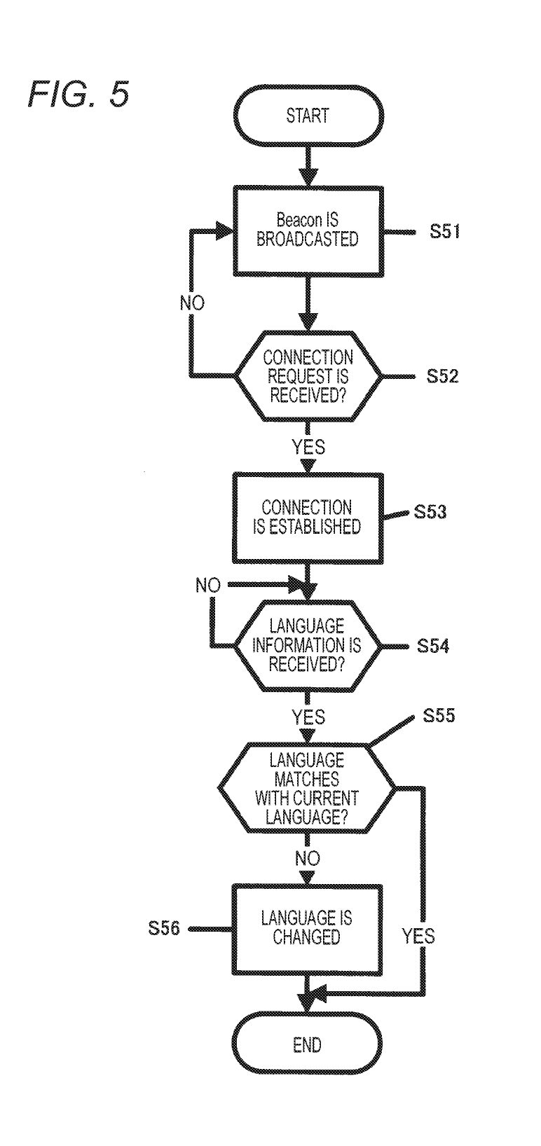

FIG. 5 is a flowchart of content output processing of the digital signage device 1. The digital signage device 1 refers to the image data storage unit 151 and projects a content. The digital signage device 1 acquires audio corresponding to the content from the audio data storage unit 152 and reproduces the audio.

First, the digital signage device 1 broadcasts a Beacon (Step S51). The digital signage device 1 determines whether or not a connection request has been received from the terminal device 2 in response to the Beacon broadcasted in Step S51 (Step S52).

In the case where the connection request has not been received (Step S52 NO), the processing returns to Step S51 and the digital signage device 1 broadcasts a Beacon again. In the case where the connection request has been received (Step S52 Yes), the digital signage device 1 establishes connection with the terminal device 2 (Step S53).

After connection with the terminal device 2 is established, the digital signage device 1 determines whether or not language information has been received from the terminal device 2 (Step S54). In the case where it is determined that the language information has not been received (Step S54 NO), Step S54 is repeated until the language information is received.

In the case where the language information has been received (Step S54 YES), the digital signage device 1 compares language information of audio that is currently reproduced with the language information transmitted from the terminal device and determines whether or not those pieces of language information match with each other.

In the case where those pieces of language information match, reproduction is continued. In the case where it is determined that those pieces of language information do not match, the processing proceeds to Step S56, and the digital signage device 1 changes the language by referring to the audio data storage unit 152 to acquire audio data matching with the language information transmitted from the terminal device and reproducing the audio data.

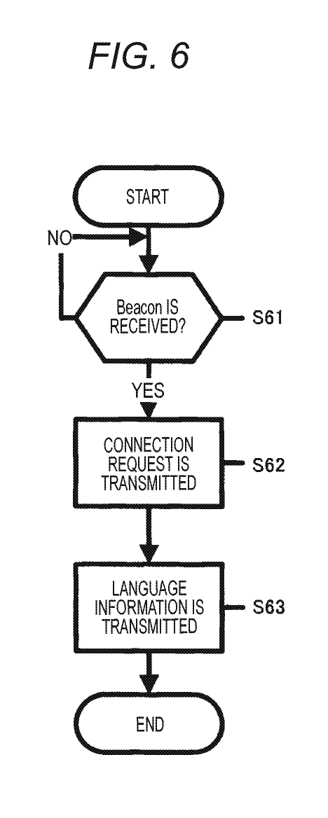

FIG. 6 is a flowchart of content output processing of the terminal device 2 according to this embodiment.

The terminal device 2 determines whether or not a Beacon has been received from the digital signage device 1 (Step S61). In the case where it is determined that the Beacon has not been received (Step S61 NO), Step S61 is repeated until the Beacon is received.

In the case where it is determined that the Beacon has been received in Step S61, the terminal device 2 specifies the digital signage device 1 that has transmitted the Beacon on the basis of identification information contained in the Beacon, transmits a connection request to the digital signage device 1 (Step S62), and establishes connection with the digital signage device 1.

After transmitting the connection request to the digital signage device 1, the terminal device 2 refers to the language information storage unit 251 to acquire a language set as a used language. After the used language is acquired, the terminal device 2 transmits language information on the used language to the digital signage device 1 (Step S63).

As described above, in this embodiment, the digital signage device 1 changes a language by acquiring language information from the terminal device 2. Therefore, it is possible to reproduce a content suitable for each user.

In this embodiment, only audio data is changed and image data is not changed. However, this embodiment is not limited thereto, and moving image data in which image data and audio data are integrated may be changed.

In the case where there is no audio data matching with language information acquired from the terminal device 2, audio data may be changed to audio data of a language which is likely to be understood, i.e., audio data may be set to, for example, English.

The embodiment described above is presented merely as an example and does not intend to limit the gist of the invention. The above new embodiment can be implemented in other various forms, and various kinds of omission, replacement, and modification can be performed within the scope of the invention. Those embodiments and modification thereof are encompassed in the scope or the gist of the invention and are also encompassed in the scope of the inventions described in claims and equivalents thereof.

What is claimed is:

1. A content output apparatus comprising:
an acquisition unit configured to acquire, from a communication partner terminal, language information used by the communication partner terminal; and
an output unit configured to output a content on the basis of the language information.

2. The content output apparatus according to claim 1, comprising
a transmission unit configured to broadcast broadcast information, wherein
the acquisition unit acquires language information from the communication partner terminal that has received the broadcast information.

3. The content output apparatus according to claim 1, wherein
the language information is language information set by the communication partner terminal.

4. The content output apparatus according to claim 2, wherein
the language information is language information set by the communication partner terminal.

5. The content output apparatus according to claim 1, comprising
a content storage unit configured to store content data, wherein
the content output unit outputs a content stored in the content storage unit.

6. The content output apparatus according to claim 2, comprising
a content storage unit configured to store content data, wherein
the content output unit outputs a content stored in the content storage unit.

7. The content output apparatus according to claim 3, comprising
a content storage unit configured to store content data, wherein
the content output unit outputs a content stored in the content storage unit.

8. The content output apparatus according to claim 4, comprising
a content storage unit configured to store content data, wherein
the content output unit outputs a content stored in the content storage unit.

9. The content output apparatus according to claim 1, wherein
the content storage unit includes a storage unit configured to store image data and an audio data storage unit configured to store audio data in a plurality of languages corresponding to the image data, and
the content output unit outputs the image data and changes audio data on the basis of the language information to output changed audio data.

10. The content output apparatus according to claim 5, comprising
a determination unit configured to determine whether or not a content corresponding to the language information acquired by the acquisition unit is stored in the content storage unit, wherein
in the case where it is determined that the content corresponding to the language information is not stored, the content output unit outputs a content in a predetermined language.

11. A content output method, comprising the steps of:
acquiring, from a communication partner terminal, language information used by the communication partner terminal; and
outputting a content on the basis of the language information.

12. A non-transitory computer-readable recording medium recording a program for causing a computer to function as:
an acquisition unit configured to acquire, from a communication partner terminal, language information used by the communication partner terminal; and
an output unit configured to output a content on the basis of the language information.
